(19) United States
(12) Patent Application Publication
(10) Pub. No.: US 2009/0212635 A1
(43) Pub. Date: Aug. 27, 2009

(54) CHARGE COUPLING AND DECOUPLING CIRCUIT

(75) Inventor: Markos Pantelis Paradissis, Vermilion, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: MV CIRCUIT DESIGN INC., Vermilion, OH (US)

(21) Appl. No.: 12/389,771

(22) Filed: Feb. 20, 2009

Related U.S. Application Data
(60) Provisional application No. 61/030,310, filed on Feb. 21, 2008.

(51) Int. Cl. H02J 1/00; H02J 7/00

(52) U.S. Cl. 307/80; 320/103

(57) ABSTRACT

A supplemental power supply includes output terminals configured to provide power to an external load, first input terminals configured to receive power from a first power supply, and second input terminals configured to receive power from a second power supply, the second power supply independent from the first power supply. Further, a charge coupling and decoupling circuit (CCDC) is electrically coupled to the output terminals and first and second input terminals, the CCDC configured to electrically couple one of the first input terminals or the second input terminals to the output terminals, and electrically couple or decouple the first input terminals from the second input terminals.

### RELATED APPLICATION DATA

This application claims priority of U.S. Provisional Application No. 61/030,310 filed on Feb. 21, 2008, which is incorporated herein by reference in its entirety.

### TECHNICAL FIELD OF THE INVENTION

The present invention relates to a charging circuit for charging a plurality of power supplies, and for selectively coupling one of the plurality of supplies to a load.

### DESCRIPTION OF THE RELATED ART

In healthcare facilities, e.g., hospitals, medical products prescribed to patients may be temporarily stored in medication-dispensing units. Typically, a healthcare facility has one or more medication-dispensing units located on each floor and/or nursing station of the healthcare facility for storing medical products prescribed to patients on that floor. Each of the medication-dispensing units may include lockable storage compartments to limit access of the medical products contained therein to authorized healthcare workers. Controlled substances, such as morphine, may be segregated into individual storage compartments in a medication-dispensing unit to control access to these substances.

A healthcare worker, e.g., nurse, may log onto a medication-dispensing unit before administering medical products to patients. In order to authenticate the healthcare worker logging on, the dispensing unit may require him/her to scan an identification badge. Alternatively, the healthcare worker may gain access to the medical products in the dispensing unit with an electronic or manual key. Once logged on or otherwise granted access to the dispensing unit, the healthcare worker may pull up a list of patients assigned to him/her, including the medical products to be administered to the respective patients. The healthcare worker then may remove the medical products identified in the list of patients from the dispensing unit. In a further alternative, the dispensing unit may automatically grant the healthcare worker access to one or more individual storage compartments including medical products.

Since the login features and locking mechanisms of the medication-dispensing unit operate on electrical power, access to the unit may be inhibited during a power loss. To gain access, a battery power supply may be electrically coupled to the medication-dispensing unit, thereby making the security features of the unit operational.

### SUMMARY

A problem with such power supplies, however, is that if not properly maintained the batteries fail and/or are unpredictable with respect to their available charge. This can be problematic in a health-care environment, particularly during a power outage.

An apparatus in accordance with the present invention comprises a circuit that controls power to a common load from two different power supplies. Further, the circuit provides a charging means for charging at least one power supply from the other power supply. The apparatus in accordance with the present invention can be part of a supplemental power supply system for providing power to electronic devices. Preferably, the supplemental power supply system is a portable apparatus that can be carried by hand, or mounted on a cart such that it can be wheeled from location to location.

According to one aspect of the invention, a supplemental power supply includes: output terminals configured to provide power to a load; first input terminals configured to receive power from a first DC power supply; second input terminals configured to receive power from a second DC power supply, said second DC power supply independent from said first DC power supply; and a charge coupling and decoupling circuit (CCDC) electrically coupled to said output terminals and first and second input terminals, said CCDC configured to electrically couple one of the first input terminals or the second input terminals to the output terminals so as to provide electric power from the first or second DC power supply to the load, and electrically couple or decouple the first input terminals to/from the second input terminals so as to charge the second DC power supply from power provided by the first DC power supply when the first DC power supply is powering the load.

According to one aspect of the invention, the supplemental power supply includes the first and second power supplies comprise a battery. The batteries are rechargeable batteries, and can be any one of a lithium-ion battery, a nickel-metal hydride battery, a nickel-cadmium battery, or a lead-acid battery.

According to one aspect of the invention, the CCDC includes a monitoring circuit electrically coupled to the first and second input terminals, the monitoring circuit configured to compare a charge level of the first DC power supply relative to a charge level of the second DC power supply and to output a result of the comparison. The monitoring circuit can include a comparator electrically coupled to the first input terminals and the second input terminals, the comparator configured to compare the charge level of the first and second DC power supplies.

According to one aspect of the invention, the CCDC includes a scaling circuit configured to receive a voltage at the first and second input terminals, scale the respective voltages, and provide the scaled voltages to the monitoring circuit.

According to one aspect of the invention, the CCDC includes a switching device electrically coupled to the monitoring circuit, the switching circuit configured to electrically couple the first input terminals or the second input terminals to the output terminals based on the output from the monitoring circuit.

According to one aspect of the invention, the CCDC includes a charging circuit configured to provide a charge current from the first input terminals to the second input terminals so as to charge the second DC power supply from power provided by the first DC power supply.

According to one aspect of the invention, the charging circuit includes a diode having an anode and a cathode, the anode operatively coupled to a positive input of the first set of input terminals and the cathode operatively coupled to a positive input of the second set of input terminals.

According to one aspect of the invention, the CCDC includes a decoupling circuit configured to decouple the positive terminal of the first set of input terminals from the positive terminal of the output terminals when the positive terminal of the second set of input terminals is coupled to the positive terminal of the output terminals.

According to one aspect of the invention, a method for providing power to a load via a supplemental power supply is provided, the supplemental power supply including a first power supply and a second power supply independent from the first power supply. The method includes determining a charge level of the first power supply relative to the second power supply; electrically coupling one of the first power supply or the second power supply to the load based on the determined charge level of the first and second power supplies; and charging the second power supply from the first power supply.

According to one aspect of the invention, charging includes charging the second power supply when a load is not attached to the supplemental power system.

According to one aspect of the invention, determining a charge level includes: comparing the charge level of the first power supply to a charge level of the second power supply; and outputting a result of the comparison.

According to one aspect of the invention, comparing the charge level includes scaling the charge levels prior to making the comparison.

According to one aspect of the invention, charging includes using a diode and resistor to provide a charge to the second power supply from the first power supply.

According to one aspect of the invention, a method of providing supplemental power to a medication dispensing unit includes: coupling the output terminals of the supplemental power system of claim 1 to the medication dispensing unit; providing power to the medication dispensing unit via one of the first power supply or the second power supply; and charging the second power supply from power derived from the first power supply.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic diagram illustrating an exemplary supplemental power supply in accordance with the present invention.

FIG. 2 is a schematic diagram illustrating an exemplary charge coupling and decoupling circuit in accordance with the present invention.

FIG. 3 is a detailed schematic diagram of the exemplary charge coupling and decoupling circuit in accordance with the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

A charge coupling and decoupling circuit (CCDC) is provided that controls power to a common load from two independent power supplies (e.g., a main supply and an auxiliary supply), such as independent DC batteries, for example. Selection of the power supply that is to be coupled to the load can be performed automatically by the CCDC based on an available charge in the respective power supplies. Further, the CCDC is configured to charge at least the auxiliary power supply from power provided by the main power supply when the auxiliary power supply is not coupled to the load.

For example, in a system that includes a main power supply and an auxiliary power supply, the CCDC diverts some power from the main power supply to the auxiliary power supply when the main power supply is providing power to the load. This ensures that the auxiliary power supply remains fully charged should the main supply be exhausted. Further, while the auxiliary supply is being charged, the CCDC maintains the auxiliary supply in a decoupled state from the load. This prevents the auxiliary supply from providing power to the load, thereby preserving its capacity for use at time of need.

Further, the CCDC can be configured to automatically couple either the main or auxiliary power supply to the load. For example, the CCDC can monitor the available charge in each power supply, and when the available charge in the source coupled to the load (e.g., the main source) drops below a predetermined level, the CCDC can automatically decouple the main supply from the load and couple the auxiliary supply (or vice-versa) to the load.

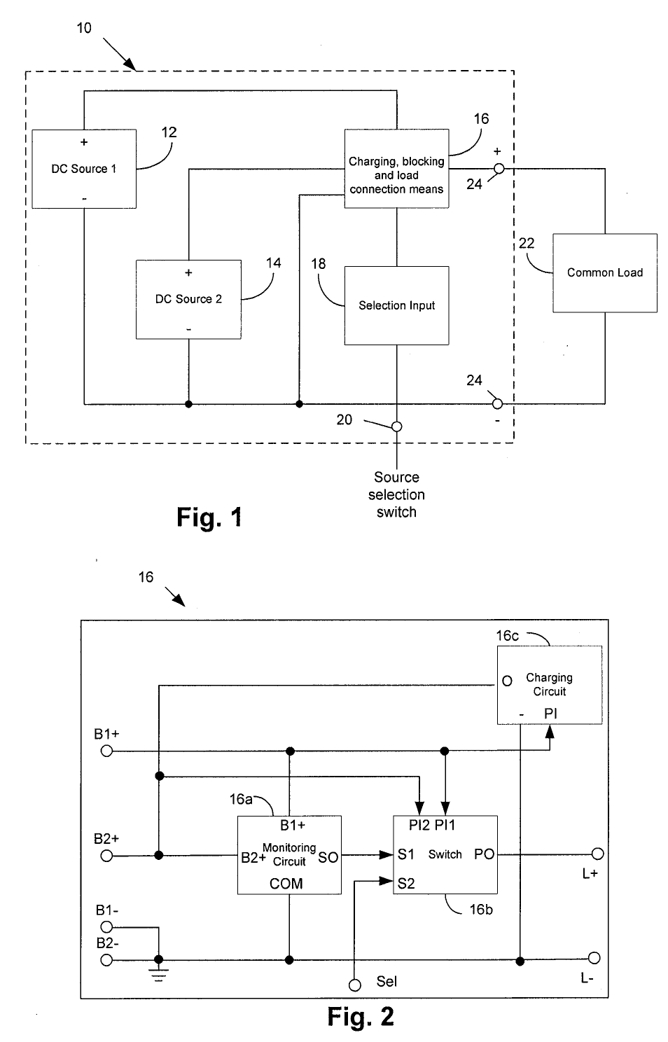

Referring now to FIG. 1, there is shown a schematic diagram illustrating a supplemental power system 10 in accordance with the present invention. The system 10 can be used to provide power to a load, such as electronic devices, during a power outage, or when power is not available in a particular area (e.g., a room not wired for power). The system 10 includes a first or main power supply 12, and a second or auxiliary power supply 14. The main and auxiliary power supplies 12 and 14 can be batteries that provide DC power, for example, and may employ any conventional rechargeable battery technology. Preferably, the batteries are lithium-ion batteries, although other batteries, such as nickel-metal hydride, nickel-cadmium, lead-acid, etc., can be used depending on the particular application. A negative pole of the main power supply 12 is electrically coupled to a corresponding negative pole of the auxiliary power supply 14. Further, a positive pole of each power supply 12 and 14 is electrically coupled to the CCDC 16.

Optional selection means, such as a selector switch or the like, can be operatively coupled to an input circuit 18 via input terminals 20. Although only a single terminal is shown, it will be appreciated that multiple terminals may be present depending on the configuration of the input device. The input circuit 18, which is operatively coupled to the CCDC 16, acts as an input buffer between the selection means and the CCDC 16, and may employ conventional techniques for communicating the status of an external device, such as a switch, to a digital circuit or the like, as well as providing a level of electrical protection (e.g., electrical isolation). A load 22, such as a medical dispensing unit, can be electrically coupled to the system 10 via output terminals 24. As noted above, based on a charge level of each power supply 12 and 14 and user input, the CCDC 16 will couple one of the power supplies to the load, and charge the other power supply.

Moving now to FIG. 2, there is shown a block diagram of an exemplary CCDC 16 in accordance with the invention. The CCDC 16 includes main and auxiliary positive input terminals B1+ and B2+ for electrically coupling to positive terminals of the respective power supplies 12 and 14, as well as B1− and B2− input terminals for coupling to negative terminals of the respective power supplies. The B1− and B2− terminals are electrically coupled to common of the CCDC 16. A monitoring circuit 16a includes B1+, B2+ and COM terminals for electrically coupling to the power supplies 12 and 14, and is configured to determine the available charge for each power supply. Further, the monitoring circuit 16a, based on the determination, is configured to provide a selection output SO to a selection input SI of switch 16b so as to select the appropriate power supply for coupling to the load 22. More particularly, the monitoring circuit 16a determines when the main power supply (e.g., the power supply corresponding to the B1+ terminal) has depleted its charge to a predetermined level (e.g., 5% or less available charge). When this occurs, the monitoring circuit 16a outputs a command to switch 16b to select the power supply corresponding to the B2+ terminal (or vice-versa, depending on the particular circumstances). This B2+ selection may be maintained until the power supply corresponding to the B2+ terminal has depleted its charge to the predetermined level, at which point analysis of the two power supplies 12 and 14 can again be performed.

As noted above, the monitoring circuit 16a provides a selection output to a first selection input S1 of switch 16b. Switch 16b also includes two power inputs PI1 and PI2, which are electrically connected to terminals B1+ and B2+. Optional second selection input S2 of switch 16b is configured to receive data from the selection input block 18 (e.g., data corresponding to an optional user selector switch). Inputs PI1 and PI2 are selectively coupled to an output PO of the switch 16b based on the status of first selection input S1 and second selection input S2. More particularly, the switch 16b is configured such that when the second selection input S2 corresponds to an “auto” selection (e.g., the user selector switch is placed in an automatic position), the switch 16b will base the selection of inputs PI1 and PI2 on the first selection input S1, which is the selection provided by the monitoring circuit 16a. If the data provided on the second select input S2 does not correspond to auto mode, then the switch 16b will base the selection of inputs PI1 and PI2 on the data provided on the second selection input S2. The power output PO of switch 16b is electrically coupled to a load terminal of the CCDC 16 so as to electrically couple the selected power supply to the load.

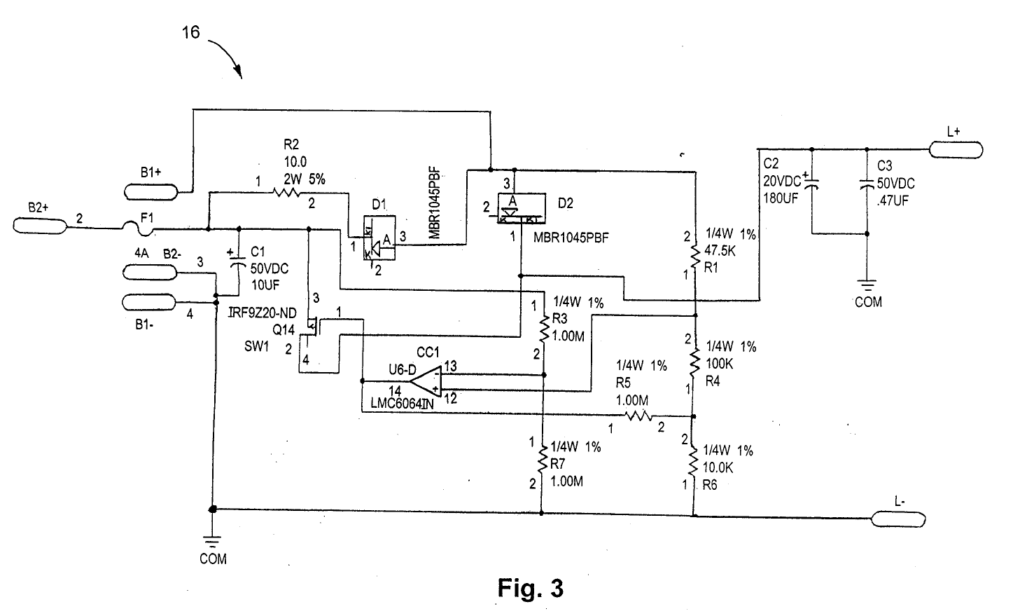

Charging circuit 16c is electrically connected to the main power supply terminal B1+, and is configured to provide a charge from the main power supply 12 to the auxiliary power supply 14 so as to maintain the auxiliary power supply 14 in a fully charged state. Preferably, the current provided to the auxiliary power supply 14 is a low level charge (e.g., a trickle charge). The power output PO of the charging circuit 16c is provided to the auxiliary power supply B2+ terminal (and thus to the auxiliary supply 14). Further details with respect to the charging circuit 16c are provided below with respect to FIG. 3.

Accordingly, the CCDC 16 is configured to select which power supply to provide to the load. Further, the CCDC 16 maintains the auxiliary power supply 14 in a fully charged state.

Moving now to FIG. 3, there is shown an exemplary CCDC 16 in accordance with the present invention. The CCDC 16 includes a first set of terminals B1+ and B1− for connecting to the main power supply 12, and a second set of terminals B2+ and B2− for connecting to the auxiliary power supply 14. Terminal B1+ is electrically coupled to an anode of a first diode D1, to an anode of second diode D2, and to a first terminal of resistor R1. The cathode of the first diode D1 is electrically coupled to a first terminal of resistor R2, while the second terminal of resistor R2 is electrically coupled to drain terminal of FET SW1, to a first terminal of capacitor C1, to a first terminal of resistor R3, and to terminal B2+ via fuse F1. The second terminal of capacitor C1 is electrically coupled to terminals B1−, B2− and common.

The cathode of second diode D2 is electrically coupled to the source terminal of FET SW1 (P-channel device), and to the load terminal L+, while load terminal L− is coupled to common. Capacitors C2 and C3 are coupled between common and the load terminal L+.

Moving back to resistor R1, its second terminal is electrically coupled to the plus input of comparator CC1, and to a first terminal of resistor R4. The second terminal of resistor R4 is electrically coupled to first terminals of both resistors R5 and R6.

With respect to resistor R3, its second terminal is electrically coupled to the minus input of comparator CC1, and to a first terminal of resistor R7. The second terminal of resistor R7 is electrically coupled to a second terminal of resistor R6 and to common. The output of comparator CC1 is electrically coupled to the gate terminal of FET SW1 and to a second terminal of resistor R5.

In operation, diode D1 and resistor R2 act as a charging circuit for charging the auxiliary power supply 14. More specifically, the main power supply 12 provides DC power to terminals B1+ and B1− and, thus to the anode of diode D1. Assuming the charge on the main power supply 12 is not depleted, diode D1 is forward biased and, thus, power is provided from terminal B1+ to terminal B2+ via resistor R2 and fuse F1. In the event that the main power supply 12 is depleted (or that the auxiliary source 14 has a greater charge than the main power supply 12), diode D1 is reverse biased and acts as a disconnect device that effectively prevents the auxiliary supply 14 from charging the main power supply 12. Capacitor C1 acts as a filter for the DC power provided by and/or to the auxiliary source 14.

Preferably, resistor R2 is sized such that the charging current provided to the auxiliary power supply 14 is about one amp or less. Fuse F1, which provides short-circuit protection for the supplemental power supply, is preferably sized according to the intended load of the supplemental supply (e.g., 125% of the rated current delivered by the supplemental supply). Preferably, fuse F1 is a slow-blow fuse.

Moving now to the switching logic that determines whether the main power supply 12 or the auxiliary power supply 14 are coupled to the load terminal L+, comparator CC1 monitors the voltage of both the main source 12 and auxiliary source 14. More specifically, the voltage of the auxiliary power supply 14 is provided to the minus input of comparator CC1 via resistor R3, and the voltage of the main power supply 12 is provided to the plus input of comparator CC1 via resistor R1. Resistors R3 and R7 form a voltage divider network for scaling the auxiliary voltage signal to the minus input of comparator CC1, and resistors R1, R4 and R6 form a voltage divider network for scaling the main voltage signal provided to the plus input of comparator CC1. Preferably, the scaling of the respective voltage divider networks is such that the comparator CC1 does not trigger (i.e., its output does not change from a positive output voltage to a negative output voltage) until the main source 12 has reached a charge capacity that is a predetermined level below the charge capacity of the auxiliary source 14.

If the signal provided to the positive terminal of comparator CC1 is greater than the signal provided to the negative terminal of comparator CC1, then the comparator CC1 will output a positive voltage. However, if the signal provided to the positive terminal of comparator CC1 is less than the signal provided to the negative terminal of comparator CC, then the comparator CC1 will output a negative voltage. This positive or negative Is voltage is provided to the gate terminal of FET SW1.

When the gate of FET SW1 is provided with a positive voltage by comparator CC1, the p-channel FET SW1 is effectively off (e.g., it acts as an open switch) and, thus, the auxiliary power supply 14 is not connected to the load terminal L+, and diode D2 is forward biased thereby connecting the main power supply 12 to load terminal L+. However, when the gate terminal of FET SW1 is provided with a negative voltage, then the p-channel FET SW1 turns on and the drain terminal is effectively coupled to the source terminal (e.g., the FET acts as a closed switch). This causes the B2+ terminal to be electrically coupled to the load terminal L+ and, thus, the auxiliary power supply 14 provides power to the load. Further, since a negative voltage at the gate of FET SW1 means the main power supply 12 is depleted, diode D2 is reverse biased and thus, the main power supply 12 is effectively decoupled from the load terminal L+. Capacitors C2 and C3 provide filtering for the supplied power.

Although the exemplary CCDC 16 of FIG. 3 does not illustrate the optional user selection circuitry shown in FIG. 2, such circuitry can be added by selectively decoupling the output of the comparator CC1 from the gate terminal of FET SW1, and selectively coupling a positive or negative voltage to the gate terminal. More specifically, a selector switch may have an auto position, a main power supply position and an auxiliary power supply position. When the selector switch is in the auto position, the output of comparator CC1 is electrically coupled to the gate and, thus, the comparator CC1 determines which power supply will power the load. When in the main or auxiliary power supply position, the comparator output is decoupled from the gate. Further, if the selector switch is in the main power supply position, the selector switch can be configured to provide a positive voltage to the gate terminal of FET SW1, and when in the auxiliary power supply position, the selector switch can be configured to provide negative voltage to the gate of FET SW1.

The supplemental power system 10 can be used to provide power to a medication-dispensing unit during a period of power outage. Preferably, the supplemental power system 10 includes a cart and/or wheels that enable easy transport of the system. However, the supplemental power supply system may be configured to be carried by hand. An exemplary medical dispensing unit that can be powered by the supplemental power supply in accordance with the present invention is described in pending U.S. application Ser. No. 12/212,763 filed Sep. 18, 2008, which claims priority to U.S. Application No. 61/030,318 filed Feb. 21, 2008, both of which are hereby incorporated by reference in their entirety.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A supplemental power supply, comprising:
output terminals configured to provide power to a load;
first input terminals configured to receive power from a first DC power supply;
second input terminals configured to receive power from a second DC power supply, said second DC power supply independent from said first DC power supply; and
a charge coupling and decoupling circuit (CCDC) electrically coupled to said output terminals and first and second input terminals, said CCDC configured to
electrically couple a one of the first input terminals or the second input terminals to the output terminals so as to provide electric power from the first or second DC power supply to the load, and
electrically couple or decouple the first input terminals to/from the second input terminals so as to charge the second DC power supply from power provided by the first DC power supply when the first DC power supply is powering the load.

2. The supplemental power supply according to claim 1, wherein the first and second power supplies comprise a battery.

3. The supplemental power supply according to claim 2, wherein the batteries are rechargeable batteries.

4. The supplemental power supply according to claim 2, wherein batteries are one of a lithium-ion battery, a nickel-metal hydride battery, a nickel-cadmium battery, or a lead-acid battery.

5. The supplemental power supply according to claim 1, wherein the CCDC comprises a monitoring circuit electrically coupled to the first and second input terminals, the monitoring circuit configured to compare a charge level of the first DC power supply relative to a charge level of the second DC power supply and to output a result of the comparison.

6. The supplemental power supply according to claim 5, wherein the monitoring circuit comprises a comparator electrically coupled to the first input terminals and the second input terminals, said comparator configured to compare the charge level of the first and second DC power supplies.

7. The supplemental power supply according to claim 5, wherein the CCDC comprises a scaling circuit configured to receive a voltage at the first and second input terminals, scale the respective voltages, and provide the scaled voltages to the monitoring circuit.

8. The supplemental power supply according to claim 5, wherein the CCDC comprises a switching device electrically coupled to the monitoring circuit, the switching circuit configured to electrically couple a positive terminal of the first input terminals or a positive terminal of the second input terminals to a positive terminal of the output terminals based on the output from the monitoring circuit.

9. The supplemental power supply according to claim 1, wherein the CCDC comprises a charging circuit configured to provide a charge current from a positive terminal of the first input terminals to a positive terminal of the second input terminals.

10. The supplemental power supply according to claim 9, wherein the charging circuit comprises a diode including an anode and a cathode, the anode operatively coupled to the positive input of the first set of input terminals and the cathode operatively coupled to the positive terminal of the second set of input terminals.

11. The supplemental power supply according to claim 1, wherein the CCDC includes a decoupling circuit configured to decouple a positive terminal of the first set of input terminals from a positive terminal of the output terminals when the second set of input terminals are coupled to the output terminals.

12. The supplemental power supply according to claim 1, wherein the first, second and output terminals each comprise a positive terminal and a negative terminal.

13. A method for providing power to a load via a supplemental power supply, said supplemental power supply including a first DC power supply and a second DC power supply independent from the first power supply, comprising:
determining a charge level of the first power supply relative to the second power supply;
electrically coupling one of the first power supply or the second power supply to the load based on the determined charge level of the first and second power supplies; and
charging the second power supply from the first power supply.

14. The method according to claim 13, wherein charging includes charging the second power supply when a load is not attached to the supplemental power system.

15. The method according to claim 13, wherein determining a charge level includes:
comparing the charge level of the first power supply to a charge level of the second power supply; and
outputting a result of the comparison.

16. The method according to claim 15, wherein comparing the charge level includes scaling the charge levels prior to making the comparison.

17. The method according to claim 13, wherein charging includes using a diode and resistor to provide a charge to the second power supply from the first power supply.

18. A method for providing supplemental power to a medication dispensing unit, comprising:
coupling the output terminals of the supplemental power system of claim 1 to the medication dispensing unit;
providing power to the medication dispensing unit via one of the first power supply or the second power supply; and
charging the second power supply from power derived from the first power supply.
